(19) United States
(12) Patent Application Publication
(10) Pub. No.: US 2016/0019494 A1
(43) Pub. Date: Jan. 21, 2016

(54) SYSTEM AND METHOD FOR MONITORING MOVABLE INVENTORY

(71) Applicant: Brian Millett, Calgary (CA)

(72) Inventor: Brian Millett, Calgary (CA)

(21) Appl. No.: 14/336,790

(22) Filed: Jul. 21, 2014

(51) Int. Cl. G06Q 10/08

(52) U.S. Cl. CPC G06Q 10/087

(57) ABSTRACT

The present invention provides a system for monitoring location and usable content of chemical components using
a central database constructed and arranged with a computer storage on a non-transitory computer-readable medium, communications capability, and configurability for remote access;
at least one unit containing a chemical component;
at least one RFID tag affixed to said unit;
at least one RFID data reader configured to receive information from said RFID tag, and configured to receive additional input of data, said reader having at least one communication device constructed and arranged to communicate with said master database.

### BACKGROUND OF THE INVENTION

Many industries have significant concerns with inventory control. The petroleum drilling industry has heightened concerns in that a lack of available drilling chemicals can lead to accidents and loss of life. Current systems are deficient in that they do not provide location and content specificity of chemical containers or units as needed in the industry. The present invention addresses this need.

### SUMMARY OF THE INVENTION

According to the present invention, the inventory of chemicals utilized in the petroleum drilling industry is optimized. Currently, inventory of drilling fluids is counted by hand and is very cumbersome. There have been attempts to incorporate RFID tracking, however, they have also been met with certain deficiencies. By incorporating RFID tracking onto particularized sacs, whereby RFID tracking is coupled with information relating to usable contents, provides a significant improvement. Accurate inventory is more possible in this manner. The drilling industry has a particularized difficulty relating to remote locations, weather conditions and storage of particular chemical units. Many storage locations are outside. Products can get covered with snow or other debris that impairs location of particularized units.

The system and method of the present invention provides location information, whereby not only is the particular location of a unit ascertainable, but the usable contents are present. Accurate inventory is maintained and optimization of resources occurs.

In one embodiment, the present invention is a system for monitoring location and usable content of chemical components, said system comprising:

a central database constructed and arranged with a computer storage on a non-transitory computer-readable medium, communications capability, and configurability for remote access;

at least one unit containing a chemical component;

at least one RFID tag affixed to said unit;

at least one RFID data reader configured to receive information from said RFID tag, and configured to receive additional input of data, said reader having at least one communication device constructed and arranged to communicate with said master database.

In one embodiment, additional input of data includes information of at least one of location, full volume of container, current volume of container, depleted container contents, or combinations thereof.

The system central data base assembles and selectively outputs information on any one or more unit based on at least one of location, chemical content, current volume, or combinations thereof.

The system central data base is configured to reply to a query and provide information as to one or more units location, contents, volume, or combinations thereof.

The present invention also includes a method of monitoring chemical inventory of discrete chemical unit containers, said method comprising the steps of:

providing a system according to the present invention;

affixing an RFID tag to a single unit;

transmitting initial information about the unit selected from at least one of location, contents, volume, or combinations thereof;

optionally, moving said unit and transmitting information about the unit selected from at least one of location, contents, volume, or combinations thereof after said moving; and dispensing at least some portion of unit contents and transmitting information as to volume or amount of contents dispensed.

In one embodiment, the method is further including a second transmitting of location and content mass or volume information subsequent to said transmitting initial information and outputting at least one of location, composition, mass, volume, or combinations thereof in reply to a query for such information.

In one embodiment, the method is further including the step of providing a default value and output when a specified chemical inventory falls below the default value, said default value being at least one of mass, volume, proximity to a specified location, or combinations thereof.

### BRIEF DESCRIPTION OF THE SEVERAL VIEWS OF THE DRAWING

FIG. 1 is a schematic demonstrating the various components and commands according to one embodiment of the present invention.

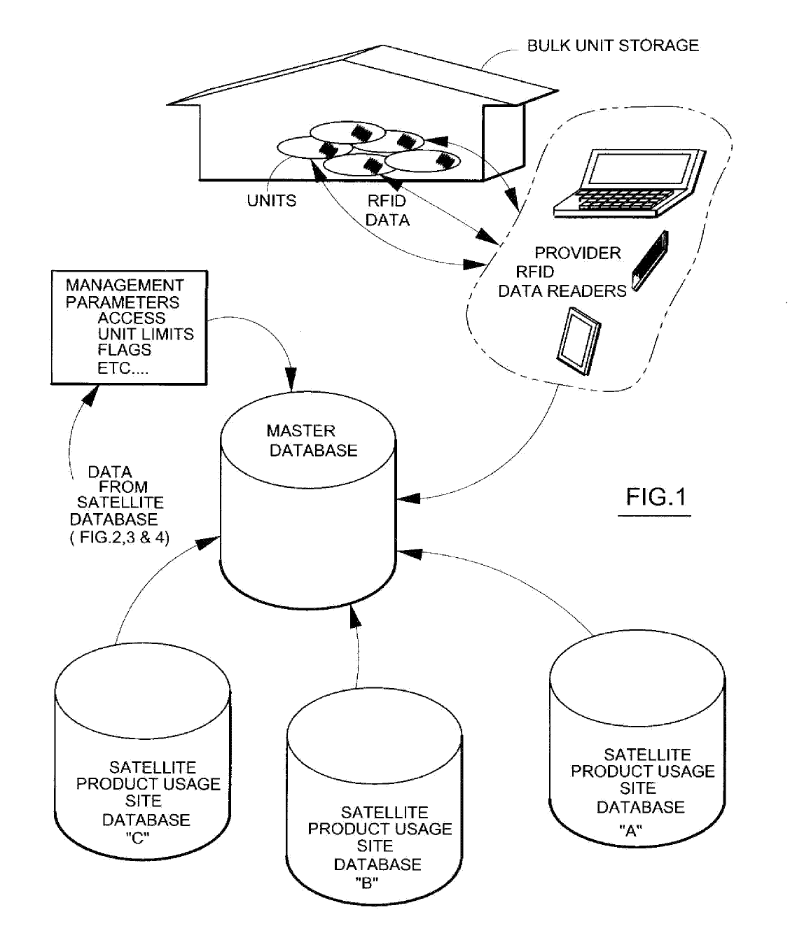

FIG. 2 is a subroutine for typical satellite site production flow control according to one embodiment of the present invention.

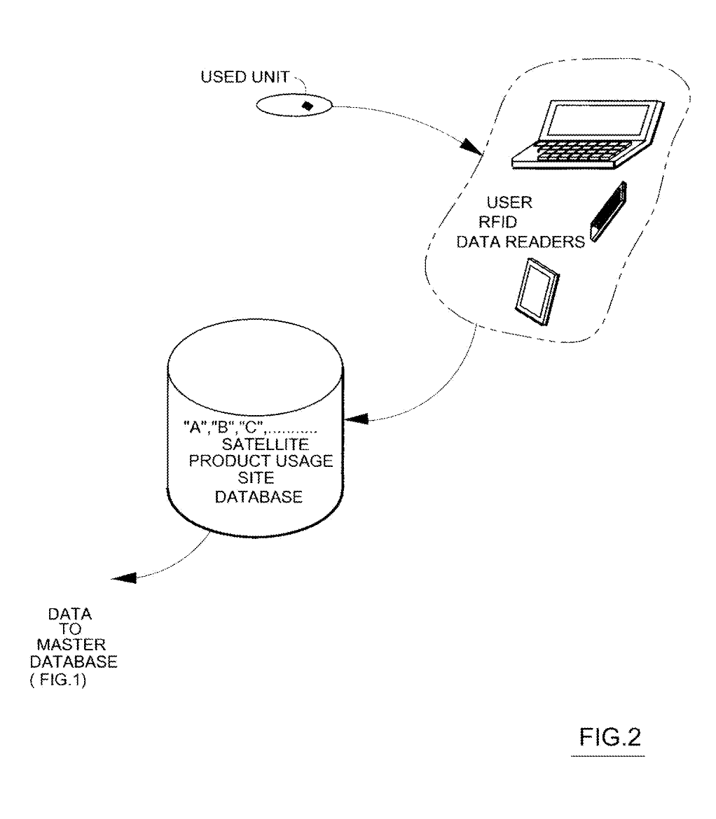

FIG. 3 is a flow chart demonstrating management decisions relating to low-level product count according to one embodiment of the present invention.

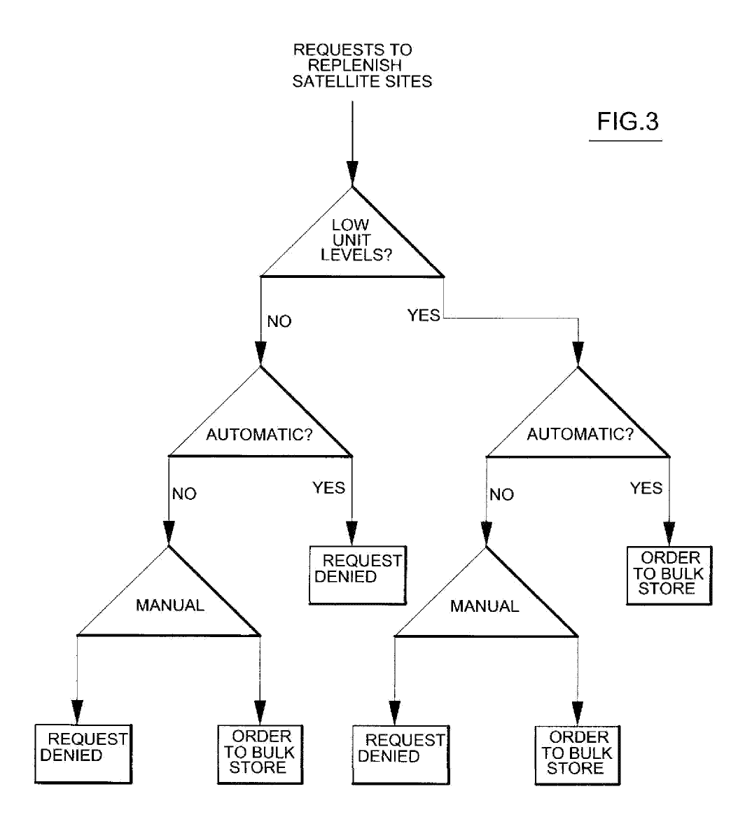

FIG. 4 is a flow chart of management decisions relating to a high-level product count according to one embodiment of the present invention.

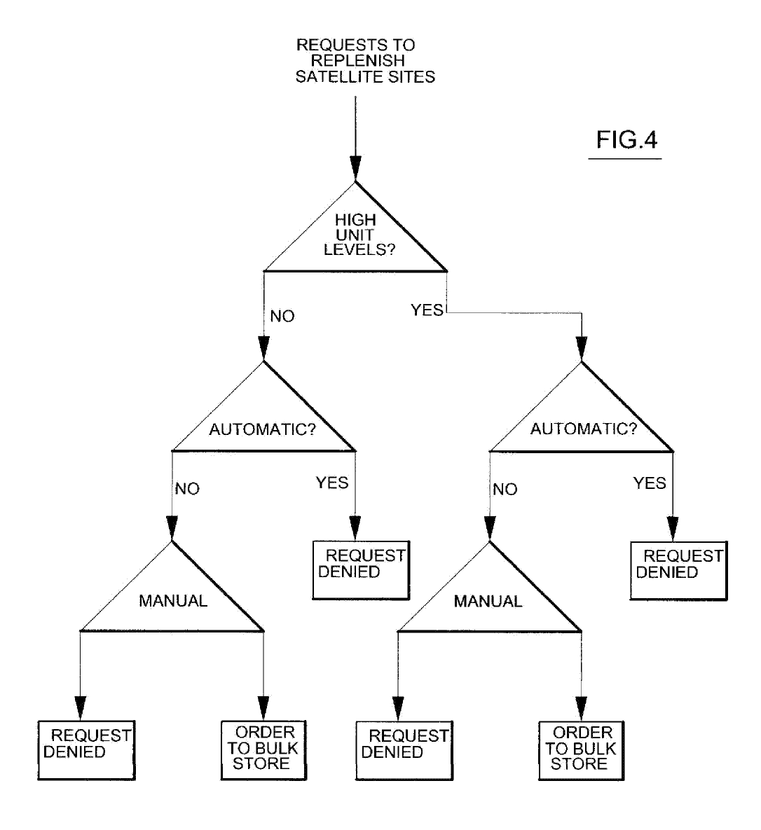

### DETAILED DESCRIPTION OF THE PREFERRED EMBODIMENT

The present invention, in general, relates to inventory control and, more specifically, to inventory control of fluid chemical components relating to the oil drilling industry. In general, the industry of oil drilling requires particular drilling fluid chemicals be present during the drilling process. However, there is difficulty relating to inventory control and management of these chemicals. An operator does not want to have an overly large stockpile at a particular site. Conversely, the operator needs to have access, often in remote areas, to the various chemicals that are required. Monitoring the position of both chemicals and supply levels are of paramount importance in the industry.

In one embodiment, a master database having a storage device, whereby the storage device is on a non-transitory, computer-readable medium, is constructed and arranged to receive management parameters relating to the drilling operation. The database is constructed and arranged to read UHF RFID identification tags that are affixed to the various chemical containers. The reader identifies the container by chemical and/or by volume, mass, or other acceptable measurements relating to usable contents. The reader transmits location and amount information to the master database. When a particular unit, being a container containing some chemical component, is moved, information about transport is also transmitted to the master database. When the unit is positioned at a drilling site, information about delivery is transmitted to the master database. As any particular unit is used in a drilling operation, the amount used is transmitted to the master database, whereby the master database keeps a record of the presence of a unit and the available contents remaining in each particular unit. When the usable contents of a unit have been depleted, the information about said depletion is also transmitted.

In one embodiment, transmission from a remote location of unit content location and contents is transmitted by satellite relay. The system is configured to not only monitor a single location, but a plurality of remote locations, and make recommendations as to transport of particular units from one remote location to another. The system is also configured to make queries as to amounts remaining at particular locations. Therefore, if a supervisor or administrator wants to check on the particular levels at a specific location, the system can be queried to ask for what units containing what chemical components are present at the location and what are the current levels of each unit. In this manner, a supervisor can monitor replenishment and plan without having to wait for a specific request from the system of the present invention.

For example, if a request is sent and low unit levels are detected, there could be an automatic dispatch of units to that location. If there is no automatic dispatch configured, a manual dispatch can be undertaken. If a request relating to replenishment levels is queried and particularized chemicals are seen to be at satisfactory levels, the system is configurable to either automatically deny any replenishment or to provide a manual denial of replenishment with an option to restore.

As generally understood, each particular unit containing particularized chemical components is configured with a threshold level depending on the particular chemical component. When the threshold level is reached, the system will automatically notify an operator or supervisor as to a threshold level. Additionally, the system is selectively configurable to send an alert when proximity to a threshold level is reached.

By way of non-limiting example, a drum unit containing 55 gallons of a particular chemical is dispatched to a remote drilling location. The threshold level is 20 gallons. That is to say, when the unit reaches a level of 20 gallons or below, replenishment is required. However, the system is selectively configurable to make an alert when the chemical content begins to approach 20 gallons. For example, every time a chemical is used and the level is below 28 gallons, a particular alert can be sent in order to demonstrate approach to the threshold level.

In one embodiment, the system is configurable to provide information as to the remote sharing and distribution of particular chemical resources. For example, travelling along a substantially straight line from a centralized command location, a first drilling site is located 80 kilometers away, and a second drilling site is located an additional 60 kilometers away. The second drilling site has sent an alert saying that a particular chemical has reached its threshold level. However, the system is alerted that the first drilling site has a surplus of the particularized chemical. Alert as to this availability allows an administrator to send an instruction to the operators at the first site to transfer a particular amount of chemical to the second site until a proper replenishment is available.

While the invention has been described in its preferred form or embodiment with some degree of particularity, it is understood that this description has been given only by way of example and that numerous changes in the details of construction, fabrication and use, including the combination and arrangement of parts, may be made without departing from the spirit and scope of the invention.

What is claimed is:

1. A system for monitoring location and usable content of chemical components, said system comprising:
a central database constructed and arranged with a computer storage on a non-transitory computer-readable medium, communications capability, and configurability for remote access;
at least one unit containing a chemical component;
at least one RFID tag affixed to said unit;
at least one RFID data reader configured to receive information from said RFID tag, and configured to receive additional input of data, said reader having at least one communication device constructed and arranged to communicate with said master database.

2. The system of claim 1 wherein said additional input of data includes information of at least one of location, full volume of container, current volume of container, depleted container contents, or combinations thereof.

3. The system of claim 1 wherein said central data base assembles and selectively outputs information on any one or more unit based on at least one of location, chemical content, current volume, or combinations thereof.

4. The system of claim 1 wherein said central data base is configured to reply to a query and provide information as to one or more units location, contents, volume, or combinations thereof.

5. A method of monitoring chemical inventory of discrete chemical unit containers, said method comprising the steps of:
providing a system according to claim 1;
affixing an RFID tag to a single unit;
transmitting initial information about the unit selected from at least one of location, contents, volume, or combinations thereof;
optionally, moving said unit and transmitting information about the unit selected from at least one of location, contents, volume, or combinations thereof after said moving; and
dispensing at least some portion of unit contents and transmitting information as to volume or amount of contents dispensed.

6. The method of claim 6 further including a second transmitting of location and content mass or volume information subsequent to said transmitting initial information.

7. The method of claim 6 further including outputting at least one of location, composition, mass, volume, or combinations thereof in reply to a query for such information.

8. The method of claim 6 further including providing a default value and output when a specified chemical inventory falls below the default value, said default value being at least one of mass, volume, proximity to a specified location, or combinations thereof.
